(19) United States
(12) Patent Application Publication
(10) Pub. No.: US 2024/0210330 A1
(43) Pub. Date: Jun. 27, 2024

(54) SYSTEMS AND METHODS FOR ARTIFICIAL INTELLIGENCE POWERED INSPECTIONS AND PREDICTIVE ANALYSES

(71) Applicant: Chi Chun Sun, Hong Kong (CN)

(72) Inventors: Harris Sun, Hong Kong (CN); MICHELE DE FILIPPO, Hong Kong (CN); Sasan Asadiabadi, Hong Kong (CN); king long edward CHAN, Hong Kong (CN)

(73) Assignee: RASPECT INTELLIGENT INSPECTION LIMITED, Hong Kong (CN)

(21) Appl. No.: 18/568,800

(22) PCT Filed: May 10, 2021
(86) PCT No.: PCT/IB2021/053937

§ 371 Date: Dec. 8, 2023

Related U.S. Application Data
(60) Provisional application No. 63/021,894, filed on May 8, 2020.

(51) Int. Cl. G01N 21/95; G05B 23/02; G06T 7/00

(52) U.S. Cl. CPC G01N 21/95; G05B 23/0283; G06T 7/00

(57) ABSTRACT

A system to identify potential building and infrastructure issues by using artificial intelligence powered assessment and predictive analysis. The system employs big data from autonomous vehicles or robots coupled with visual and thermal cameras for autonomous inspections. The system may further inspect the operation status of the machineries based on their vibrations.

### TECHNICAL FIELD

This invention generally relates to systems and methods involving interpretation of sensed data for autonomous assessments, predictive analyses, early warning and remaining life prediction.

### BACKGROUND

There are hundreds of thousands of high-rise buildings and built infrastructures such as bridges, roads, tunnels, pavements, slopes, dams, power lines etc. around the world and that number is growing every day. Taking Hong Kong as an example, it is home to more than 7,000 high-rise buildings besides innumerable other built physical infrastructure. To operate these buildings and facilities safely and efficiently a lot of operational components are installed in them, including heating, ventilation and air-conditioning systems (HVAC systems), escalators and elevators, fire safety system, security system, water supply and drainage system, electric power supply system etc. Constant inspections of the moving parts of the operational components is needed to ensure safe and reliable operation. Further, regular inspections of the structural components of the high-rise buildings including roofs, pipes and facades are also needed to ensure public safety, low maintenance cost by timely repairs and to ensure long service life. Proactive maintenance based on regular inspection and monitoring may also enhance sustainability of built infrastructure by helping to minimize energy consumption and carbon emission.

Currently, experienced human inspectors periodically perform on-site inspections of the operational and structural components of buildings. Manual selection of detection points and manual operation of measuring instruments make the process time and labor intensive, which translates to additional cost. Further, these tasks have several drawbacks. For example, from safety perspective, the human inspectors may need to work at high altitude for a long period of time, which would increase the risk of injury from accidents. From regulatory perspective, it is difficult for the government or supervising contractors to manage a large number of inspection projects due to the limited number of staff. Spot checks are often used to ensure quality. However, there may be missing spots and the inspection quality can suffer. From consistency perspective, the technical competency of the human inspectors can be uneven, which could affect the quality of the inspections.

### SUMMARY

Since building and infrastructure inspections are time-consuming and cost and/or labor-intensive tasks, automation, in one embodiment, becomes the most criterial factor of the efficacy of the infrastructure and building inspections. Additionally, automation could enhance safety, supervision and consistency. The present invention also promotes (1) understanding of common structural deterioration and their severity in existing buildings; (2) understanding on the satisfaction level of building owners regarding the current status of their assets; and (3) understanding on the remaining life and risk related to existing buildings and components.

In light of the foregoing background, aspects of the invention provide systems and methods for automated and Artificial-Intelligence (AI) powered assessments and predictive analyses in buildings and infrastructure systems.

Accordingly, embodiments of the present invention may be a non-transitory computer readable storage medium configured to store instructions that, when executed, may configure or cause a processor to perform at least the following: (1) receiving sensed data including thermal image, visual image, object vibration, electro-magnetic data such as current or magnetic field and combination thereof, (2) identifying at least one defect related information from the sensed data, wherein at least one defect related information including type of defect and degree of severity of the defect; and (3) predicting the remaining lifetime of a target where the defect was identified. Such sensed data may be from cameras such as in the case of visual and thermal images or numerical data as in case of the LASER sensor (e.g., LIDAR) or time series data as in case of internet of things (IOT) capable electro-magnetic sensors.

In other aspect, the prediction is obtained from big data analytics where sensed data are fused and analyzed.

In yet another aspect, a system for AI powered assessment and predictive analysis comprising an autonomous vehicle or robot coupled with a visual, thermal cameras and LASER sensor, a computing device comprising a non-transitory computer readable storage medium above, wherein the thermal camera is configured to collect thermal image of a target, the visual camera configured to collect visual image of the target and the LASER sensor configured to collect 3D point cloud information.

### BRIEF DESCRIPTION OF THE DRAWINGS

Persons of ordinary skill in the art may appreciate that elements in the figures are illustrated for simplicity and clarity so not all connections and options have been shown. For example, common but well understood elements that are useful or necessary in a commercially feasible embodiment may often not be depicted in order to facilitate a less obstructed view of the various embodiments of the present disclosure. It may be further appreciated that certain actions and/or steps may be described or depicted in a particular order of occurrence while those skilled in the art may understand that such specificity with respect to sequence may not actually required. It may also be understood that the terms and expressions used herein may be defined with respect to their corresponding respective areas of inquiry and study except where specific meanings have otherwise been set forth herein.

FIG. 1 is a block diagram of an example system for artificial-intelligence powered assessment and predictive analysis according to one embodiment of the present invention.

FIG. 2 is a block diagram of an example system including a local working station in communication with a server, sensor and alarm according to one embodiment of the present invention.

FIG. 3 is a flow diagram of an example computer-implemented method for artificial intelligence powered assessment and predictive analysis according to one embodiment of the present invention.

FIG. 4A depicts an example of thermal image of a water pipe according to one embodiment of the present invention.

FIG. 4B is a histogram chart of a thermal data extracted from the thermal image of FIG. 4A according to one embodiment of the present invention.

FIG. 5A a histogram chart of a thermal data after performing dynamic calibration on the histogram chart of FIG. 4B according to one embodiment of the present invention.

FIG. 5B depicts a thermal image of water pipe after dynamic calibration on the histogram chart of FIG. 4B according to one embodiment of the present invention.

FIG. 6A depicts a thermal edge image derived through Canny's edge detector on the thermal image of FIG. 5B according to one embodiment of the present invention.

FIG. 6B depicts a thermal edge after Otsu's Thresholding on grey level histogram on the thermal edge image of FIG. 6A according to one embodiment of the present invention.

FIG. 7 depicts a thermal image of detected water leakages of a water pipe according to one embodiment of the present invention.

FIG. 8 depicts a thermal image of detected roof areas with debonding of a building according to one embodiment of the present invention.

FIG. 9 depicts an image of a façade crack detection of a building according to one embodiment of the present invention.

FIG. 10 depicts an image of a detected obstacle in the comb section of an escalator according to one embodiment of the present invention.

FIG. 11 depicts an image of different elevator cable defects according to one embodiment of the present invention.

FIG. 12 depicts an image of data from structural vibration detection according to one embodiment of the present invention.

FIG. 13 depicts a graph of frequencies detected by a vibration sensor according to one embodiment of the present invention.

FIG. 14 depicts a flight procedure for survey of façade and building inspection according to one embodiment of the present invention.

FIG. 15 depicts a sample annotated image from a training dataset for macro inspection according to one embodiment of the present invention.

FIG. 16 depicts a data labelling for micro inspection of cracks according to one embodiment of the present invention.

FIG. 17 depicts a data labelling for micro inspection of delamination according to one embodiment of the present invention.

FIG. 18 depicts a data labelling for micro inspection of stains according to one embodiment of the present invention.

FIG. 19 depicts an AI architecture implemented for defects detection in the macro inspection stage according to one embodiment of the present invention.

FIG. 20 illustrates application of macro and micro inspection for visual analytics according to one embodiment of the present invention.

FIG. 21 depicts a chart showing accuracy achieved for visual analytics according to one embodiment of the present invention.

FIG. 22 depicts a sample annotated infrared image from the training dataset for macro inspection according to one embodiment of the present invention.

FIG. 23 depicts a histogram of thermal data of the image of FIG. 22 according to one embodiment of the present invention.

FIG. 24 depicts an infrared image to be inspected in one embodiment of the present invention.

FIG. 25 depicts the anomalous edges identified in the image of FIG. 24 according to one embodiment of the present invention.

FIG. 26 depicts the thermal anomalies identified in the image of FIG. 24 according to one embodiment of the present invention.

FIG. 27 depicts application of macro and micro inspection for infrared analytics to the image of FIG. 24 according to one embodiment of the present invention.

FIG. 28 depicts a summary of inspection results of a site according to one embodiment of the present invention.

FIG. 29 depicts an example of a point cloud data derived 3D model created from LASER sensor (LIDAR) survey data.

FIG. 30 depicts an example of data collected from a magnetic field IoT sensor monitoring an elevator cable.

FIG. 31 depicts an example of data collected from an current sensors and distance sensor that monitor different components of an elevator system.

### DETAILED DESCRIPTION

Embodiments may now be described more fully with reference to the accompanying drawings, which form a part hereof, and which show, by way of illustration, specific exemplary embodiments which may be practiced. These illustrations and exemplary embodiments may be presented with the understanding that the present disclosure is an exemplification of the principles of one or more embodiments and may not be intended to limit any one of the embodiments illustrated. Embodiments may be embodied in many different forms and should not be construed as limited to the embodiments set forth herein; rather, these embodiments are provided so that this disclosure may be thorough and complete, and may fully convey the scope of embodiments to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

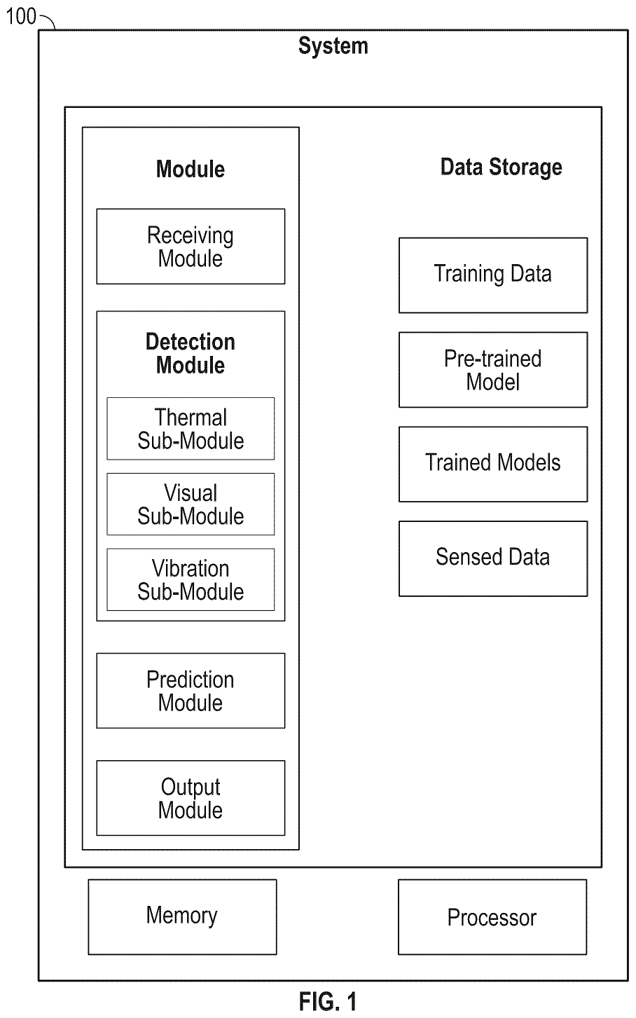

Referring to FIG. 1, a system 100 may include a data storage, a memory and a processor. The data storage generally may be any type or form of storage device or medium capable of storing data, computer readable media and/or other computer-readable instructions. For example, data storage may be a hard drive, a solid-state drive, a floppy disk drive, a magnetic tape drive, an optical disk drive, a flash drive, or the like. The processor may include but not limited to, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations thereof. The memory may include any type or form of volatile storage device capable of storing data and/or computer-readable instructions. In one example, memory may store, load, and/or maintain at least one module, training data, pre-training model, trained model and sensed data. Examples of memory include, without limitation, Random Access Memory (RAM), caches, variations or combinations thereof, and/or any other suitable storage memory.

The data storage may include one or more modules for performing one or more tasks. The module comprising receiving module, detection module, prediction module and output module. As will be explained in greater detail below, the detection module further comprises of thermal sub-module, visual sub-module, vibration sub-module, LASER sub-module and Electro-magnetic sub-module. Although illustrated as separate elements, one or more of modules in FIG. 1 may represent portions of a single module or software application. Although the sub-modules are illustrated as a module within a module, one or more of sub-modules in FIG. 1 may represent a standalone module, portions of a single module or software application. One or more of modules or sub-modules when executed by a computing device may cause the computing device to perform one or more tasks.

The data storage further comprises training data, pre-trained models, trained models and sensed data. The training data comprising both inputs and corresponding outputs, which is configured to be used to perform supervised learning in pre-trained model. The trained models are created upon completion of supervised learning in the pre-trained models using the training data. The supervised learning technique may be used for classification or for regression training. Classification techniques are used to classify inputs into among two or more possible classes. Regression, on the other hand, is used for scenarios involving somewhat continuous inputs.

As will be explained in greater detail below, the trained models comprise a defects identification trained model configured to identify different types of defects and a defect assessment trained model for each type of defect (collectively “Computer Vision Model”). The Computer vision model helps performing visual detections and assessments of buildings and infrastructures from visual sensed data. Each defect assessment trained model is configured to assess the degrees of severity of each type of defect. Training data with different types of defects were fed into a pre-trained model to create a defect identification trained model. In some examples, the defects in the training data may be labeled by domain experts. Similarly, each of the defect assessment trained models may be created by feeding different degrees of severity of a predetermined type of defect to the pre-trained model. In some examples, the model may be built using up-to-date deep learning algorithms, trained on annotated data.

As will be explained in greater detail below, the trained models may also include a defect identification trained vibration model and a vibration assessment trained model (collectively “Vibration Analysis Model”) to perform vibration detections and assessments from vibration sensed data. The Vibration Analysis Model may detect and assess different anomalous behaviors of operational components in buildings. The operational components may include but not limited to bearings, compressors, chillers, water pumps and/or combination thereof. Training data with vibration signature frequencies in vibration data corresponding to different types of defects may be fed into or incorporated into a pre-trained model to create the defect trained vibration model, whereas training data with vibration frequencies in vibration data at different stage of a pre-determined defect (i.e. different degrees of severity) may be fed into a pre-trained model to create the vibration assessment trained model. As such, each type of defect has its own vibration assessment trained model to assess the severity of the defect. In some examples, the model is built using up-to-date deep learning algorithms, such as convolutional neural networks (CNN), trained on vibration signatures in vibration data. Also, the deep learning algorithm may allow operators to train the new defect types by their expertise. The vibration data may be collected, for example (without limitation), though accelerometers, vibration sensors, ultrasonic sensors, LASER Vibrometer or combination thereof. In one example, LASER may perform a scan which is a process in which the LASER beam is generated from an emmiter of a scanner which is reflected back from the target to be received by a receiver in an instrument so that an accurate location of a point of reflection may be calculated in 3-dimensional coordinates.

In some examples, the defects identification trained model, the defect assessment trained model, the defect identification trained vibration model and the vibration assessment trained model are the modules of an AI defect detection algorithm which detects and assesses defects from visual image sensed data and object vibration sensed data. In yet some examples, the accuracy of the AI defect detection algorithm may be improved by re-training it on data including at least one predetermined feature of the sensed data or at least one predetermined feature of a training data or combination thereof. The at least one predetermined feature may be selected by a user. In some particular examples, the accuracy in detection of cracks may be improved through re-training on labeled data including that feature. For example, periodic reviews may be made regarding accuracy over a period of time against human visual inspections. Any differences between the human visual inspection and the AI identified data may be reviewed and labeled for re-training at a later time. Similarly, the accuracy in detections of stains and/or delamination may be improved through re-training on labeled data including those features.

The trained models may also include a prediction trained model. The training data related to the output of the identification trained model and the output of the assessment trained model (may or may not be after validation) were fed to a pre-trained model to create the prediction trained model. Besides the data used for the detection of anomalous behaviors and re-training may also be used for predicting future anomalous behaviors. In some examples, the prediction trained model may be combined with at least one neural network, fuzzy logic or statistical forecast by using data fusion, wherein the neural network, fuzzy logic or statistical forecast are derived from additional data including but not limited to age of the structure, materials properties, maintenance history, inspection history or combination thereof. Due to dissimilarity of buildings, the prediction performance may be improved as a result of additional data. In yet another example, big data analysis through the AI program may be employed where the sensed data and additional data are fused and analyzed to enhance accuracy. Accordingly, estimated lifetime may be predicted through the prediction trained model and maintenance may be scheduled accordingly.

The sensed data may include the data collected from at least one sensor. The sensed data is not labeled, which means it does not have corresponding outputs for the inputs. The sensed data may comprise visual sensed data and vibration sensed data. Visual sensed data in form of either still images or video may be collected by any visual camera while the vibration sensed data may be collected, for example (without limitation), though accelerometers, vibration sensors, ultrasonic sensors or combination thereof. The sensed data may be fed into the trained model or pre-trained model to obtain output. The output may include classification or regression of the sensed data.

In one embodiment, the system 100 further comprises a sensor interface configured to receive sensed data from at least one sensor.

In yet another embodiment, the sensor interface is configured to allow the processor to control the operation of the at least one sensor.

In some examples, the sensor interface may communicate with the at least one sensor to obtain sensed data through any wireless and/or wired communication protocols.

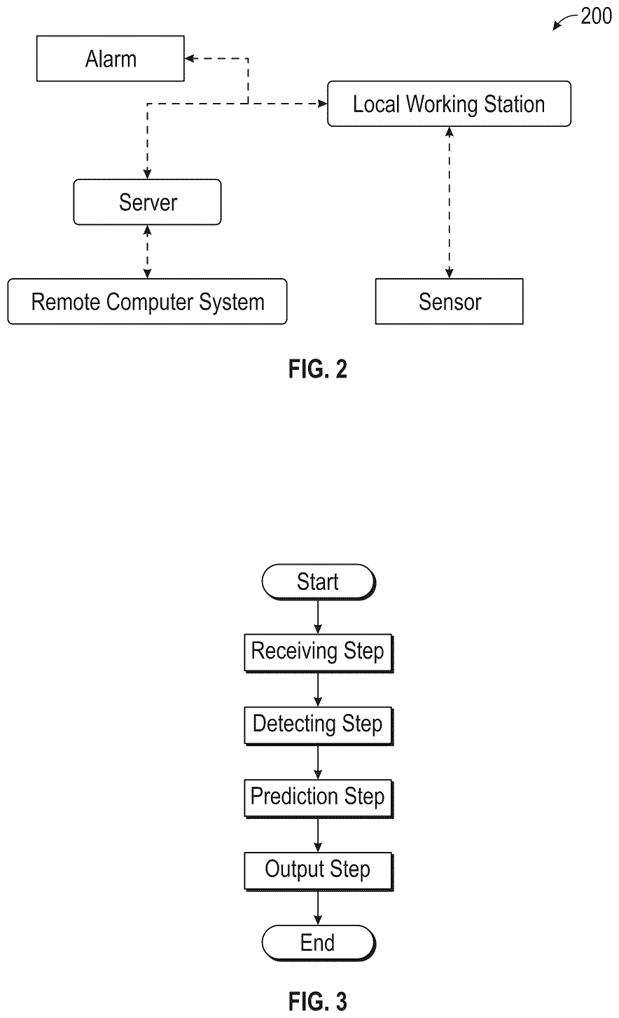

The system 100 may be implemented in a variety of ways. Referring to FIG. 2, all or a portion of system 100 may represent portions of system 200. The system 200 may also further comprises at least one sensor, an alarm or alert system for early warning, a local working station, a server, at least one remote computer system and a communication network. The communication network connects the at least one sensor, the local working station, the server, the at least one remote computer system and the alarm.

In one embodiment, the system 100 may further configure to analyse an imminent defect condition of the target component or system. For example, the system 100 may sense and based on an initial processing of the findings that the imminent defect condition is present (e.g., fire, significant structural damage due to earthquakes, cyclones, etc.). In another embodiment, the system 100 may enable the analysis of the imminent defect condition in response to external triggers, such as weather warnings, tsunami alerts, or the like. In some embodiments, the system 100 may trigger the analysis in response to a threshold, based on past defect histories, or the like. In such examples, the imminent defect condition may indicate high or significant severity with potential to cause risk to human life or major damage to the said target component or system. In response to such finding or analysis, the system 100 may immediately or upon further analysis issue an alert by SMS or email to the mobile phone or email of the owner of the target component, system or asset or trigger appropriate preventive action. Such early warning capability may be especially useful in disaster prevention or post-disaster recovery such as earthquakes or typhoons requiring immediate and quick assessment of damage and determination of safety of infrastructure for resumption of operation.

In one example, all or a portion of the functionality of modules may be performed by the local working station, the server, the at least one remote computer system, and/or any other suitable computing system (i.e. computing devices). One or more of modules from FIG. 1 may, when executed by at least one processor of the one or more computing devices, enable them to perform automated and AI powered detections/identifications, assessments and predictive analyses. At least one sensor may feed the data it collected to one or more computing devices. The alarm may be triggered by one or more computing devices when a predetermined operation parameter passes a threshold. The alarm may be triggered by the threshold limit set by a user, for example, when the remaining lifetime is 10% of its designed lifetime.

The sensor may include, but not limited to, camera, thermal camera, vibration sensor, accelerometers, ultrasonic sensors, LASER based sensors, electro-magnetic sensors or combination thereof.

In some examples, at least one sensor may be installed on or carried by a drone or autonomous vehicle such that the sensor may collect data around and on top of the target. The data collected by the at least one sensor may be stored in a memory storage device on the drone or autonomous vehicle to be transferred later to one or more of the computing devices or transferred real time using 5G mobile network connection. In yet some embodiments, the drone or autonomous vehicle may transfer its location data to the one or more computing devices using 5G mobile network connection.

In some examples, at least one the sensors is a vibration sensor and it may be installed on a bearing, compressor, chiller, water pump and/or combination thereof. In one specific example, two sensors may be installed on the chiller, one at the motor drive end and one at the compressor driven end. In yet another specific example, two sensors may be installed on the water pump, one at the motor drive end and one at the pump driven end.

In some examples, the local working station may be a desktop computer, a laptop computer, a tablet, a cellphone, a combination thereof, and/or any suitable computation devices.

In some examples, the communication network may include a Wi-Fi hotspot. In some other examples, the communication network maybe any wireless and/or wired communication protocols including 5G mobile networks.

In some examples, the server may be a cloud server.

In some examples, the system 200 may not include an alarm.

Referring now to a method for AI powered automated data analytics and AI powered assessment and predictive analyses, such method may be a computer implemented method performed by the system 100 or system 200. Each of the steps may be performed by computer-executable code with suitable computing system. In some examples, each step may represent an algorithm that includes and/or is represented by multiple sub-steps.

Referring to FIG. 3, at receiving step, the receiving module is executed. The receiving module may request and receive or be caused to receive sensed data. The sensed data may be transmitted directly from at least one sensor in real time. Alternatively, the sensed data may be accessed from the data storage in the system or the unmanned aerial system (UAS).

At detecting step, the detecting module is executed. The detecting module may together or selectively detect all thermal anomalies, surface anomalies, electro-magnetic and vibration anomalies. These anomalies are related to the defects.

Defects including but not limited to water leakage, moisture trapping, roof debonding, delamination, thermal leakage, the health of battery, health of low voltage/high voltage (LV/HV) switch box and/or other defects which includes sharp and gradual changes in temperature may be detected by executing the thermal sub-module. As will be explained in greater detail below, the thermal images or videos in the sensed data may be fed into the thermal sub-module to identify the defects.

Similarly, defects including cracks, stains, reinforcement corrosion, missing tiles, concrete honeycombing, concrete delamination, concrete peeling, concrete bulging, concrete spalling, exposed bars, lift cables fractures or fatigues and/or obstacles at escalator comb section may be detected by executing the visual sub-module. As will be explained in greater detail below, the visual images or videos in the sensed data may be fed into the visual sub-module to locate the defects. Visual sub-module may further detect air conditioners, windows, doors, roofs, signboards, balconies, glass panel, fixing and/or sealant for identification purposes. Defects including leakage or lack of refrigerant or any other machine failures may be detected by executing the vibration sub-module. As will be explained in greater detail below, the sensed vibration data in the sensed data may be fed into the vibration module to locate the defects. Defects including anomalies in cables in lifts or cranes, or any other machines may be detected executing the electro-magnetic sub-module. Similarly, energy management of the building may be optimized using the energy sub-module by detecting IoT sensors set up for the purpose.

Upon the detections of respective defects, data in relation to the defects may be fed to an optional prediction step. The defects data includes but not limited to type of defect and/or severity of the defect. At prediction step, the remaining lifetime of the defects and/or structures is estimated by using the prediction trained model. In some examples, the prediction model may be combined with at least one neural network, fuzzy logic or statistical forecast by using data fusion. Due to dissimilarity of buildings and other target structures, the prediction performance may be improved as a result of additional data, such as façade image analysis, historical landmark identification (where specific architectural features are identified and age of the building, etc.,), repair and maintenance history, and government building registration information. In some other examples, big data analysis through the AI program may be employed where the sensed data and the additional data are fused and analyzed to enhance accuracy of lifetime prediction. In yet other examples, the defects data is continuously streamed and connected to the prediction trained model, which is continuously analyzing the defects data for batch of fixed size.

At output step, the locations of the defects and the estimated remaining lifetimes may be consolidated and presented to the users in a form of reports and/or dashboards. The data in the reports and/or dashboards includes but not limited to project overview, master plan of the project, inspection scope, inspection type, building details, building location, regional distribution, building score, building analysis, recommendations, the location and severity of the defects and the remaining lifetime of the same.

In some examples, big data analysis through the AI program, for example data fusion, may be employed to further give a more accurate prediction on their lifetime.

In some examples, the data may be incorporated into a Building Information Modeling (BIM) for structural analysis and real time data visualization.

In some examples, the data, the report or the dashboard maybe uploaded to the cloud for storage or further analysis. For example, FIG. 29 is an example of a point cloud data derived 3D model created from LASER sensor (LIDAR) survey data

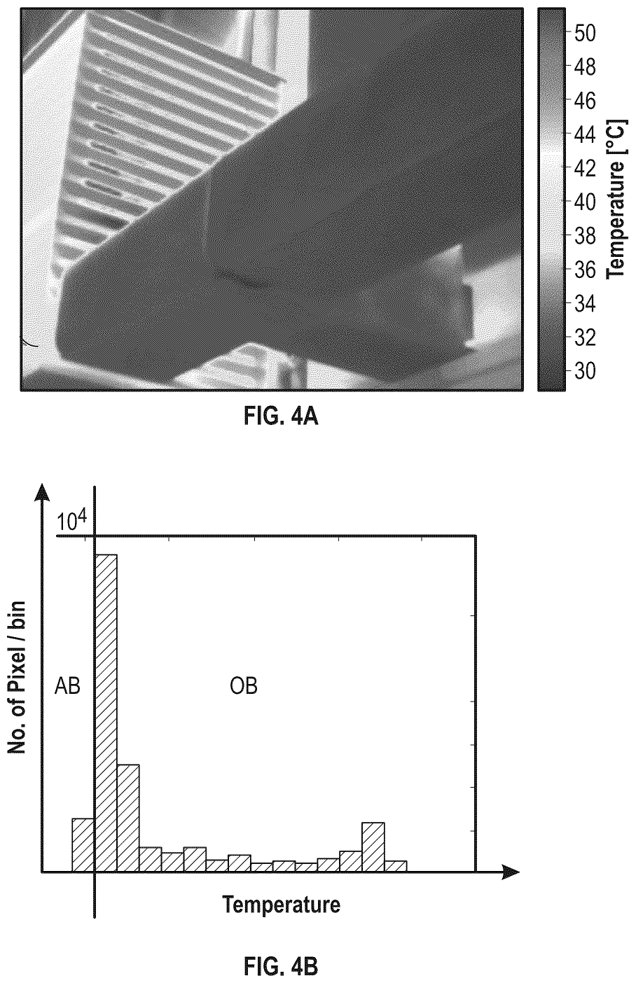

Greater detail of the thermal anomalies detection is now discussed herein. Referring to FIG. 4, the thermal anomalies detection in the thermal sub-module includes initial model calibration step, dynamic calibrations step, identification of thermal edges step, and leakage segmentation step.

At initial model calibration step, thermal images or videos from the sensed data are post-processed in the form of two-dimensional matrices, where each cell (representative of a pixel) is associated to a temperature value. For illustration purposes, referring to FIG. 4A, a thermal image of is being post-processed. According to a tentative initial Bin Width (BW), the histogram as shown in FIG. 4B is obtained. The histogram is likely to show tendency toward cold or hot regions in distinct materials with different thermal capacitance according to the season. As first assumption, in case the histogram has a cold tendency, an Anomaly Bin (AB) and an Opposite Bin (OB) are initially defined as coldest and hottest bin, or vice versa in a hot scenario. Accordingly, an Anomaly Threshold (AT) is defined for temperatures ‘entering’ the AB, BW, AB, OB and AT are key parameters of the algorithm.

At dynamic calibration step, it is first assumed that if the number of pixels in the OB is less than a significance lower bound, then such data are probably irrelevant particulars and they are filtered off. Accordingly, the AT is shifted by BW and the neighbor bin becomes the ‘new OB’. Such procedure is repeated until the condition OB≥α is satisfied, where α is a lower bound, typically about 0.1.

Second, it is assumed that if there is more than one pixel peak in the histogram, then the pixels distribution still contains irrelevant information which may lead to false positives (such as background or sky). In such case, it is very likely that relevant information is within mid-range temperatures. Eventual irrelevant peaks (with an amount of pixels not exceeding 10% of the total pixels) and their bounding pixels are filtered off.

Third, it is assumed that if the number of pixels in the AB is greater than a significance upper bound B, then n and BW are not adequate, therefore n is increased by a pre-defined growth ratio and BW decreases accordingly. The overall calibration is repeated until the condition AB≤B is satisfied, where n is number of bins and B is an upper bound, typically about 0.9.

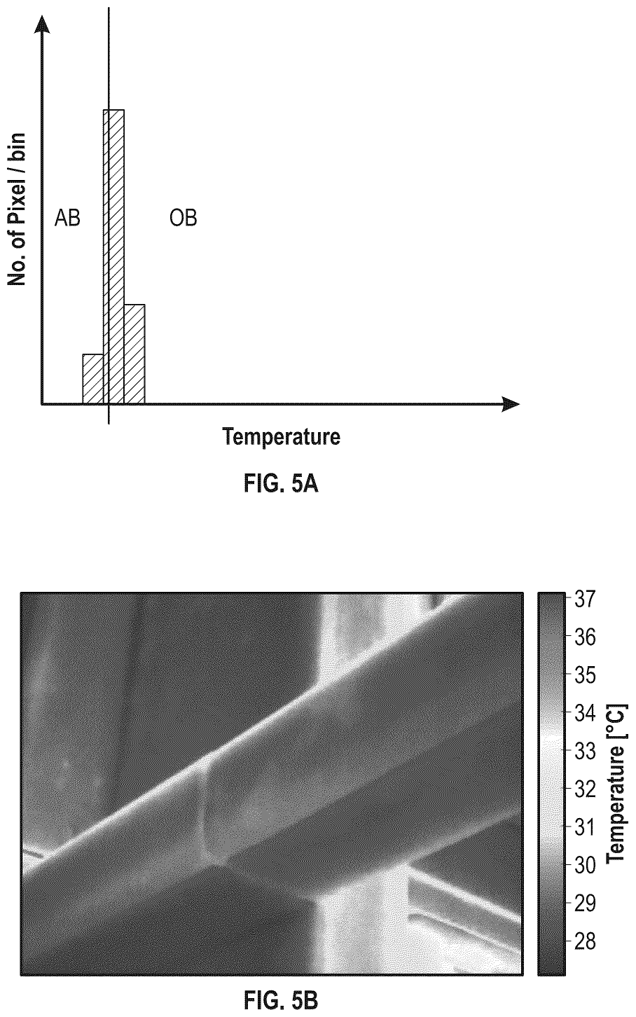

After the initial model calibration step, the configuration of data shown in FIGS. 4A and 4B to the one shown in FIGS. 5A and 5B. It is now clear that the amount of data has been significantly reduced and relevant data not discarded.

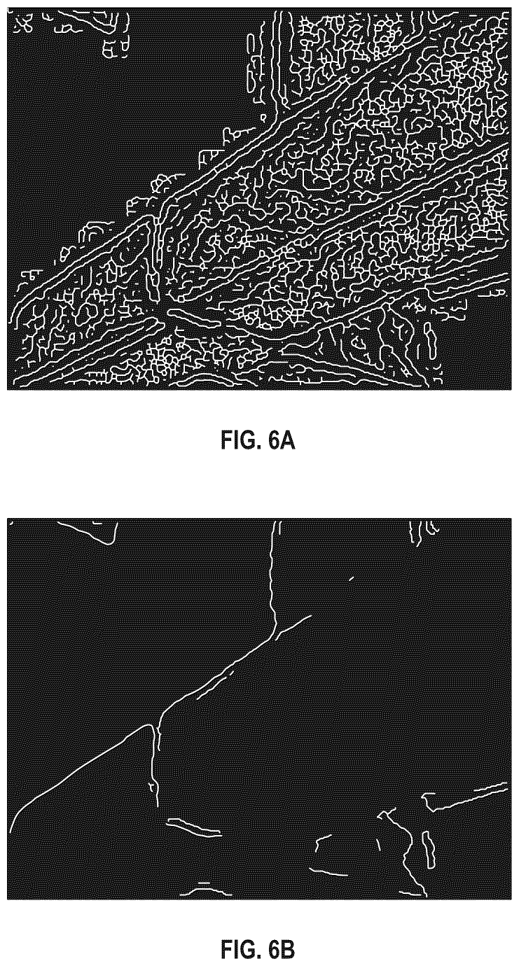

At identification of thermal edges step, the thermal edges may be identified using a Canny edge detector, obtaining the results shown in FIG. 6A. Irrelevant thermal edges are filtered off using Otsu Thresholding Method on a gray-level histogram, and the results are displayed in FIG. 6B. Evidently, all irrelevant thermal edges are filtered off whilst the edges defining the contour of the beam and regions with sharp changes in temperature are not discarded.

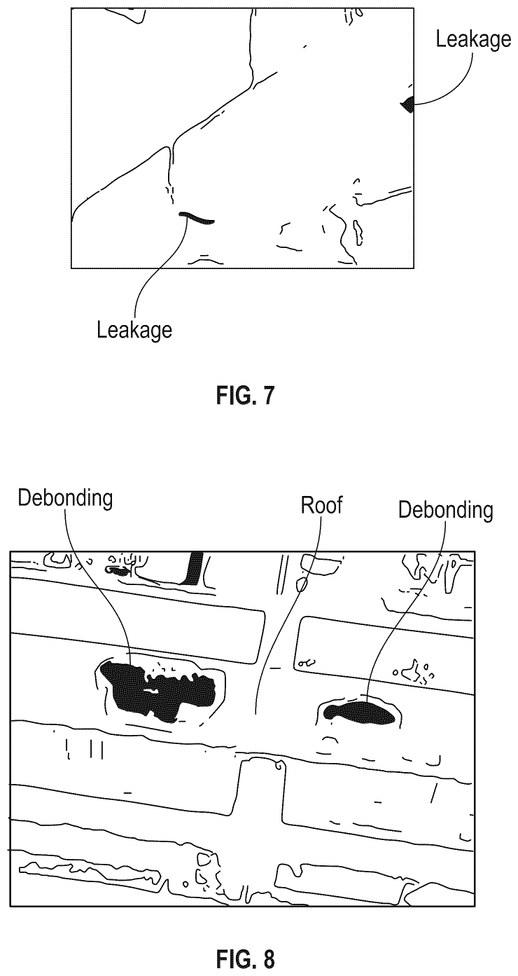

At leakage segmentation step, it is assumed that leakage will lie somewhere close to the identified thermal edges. Regions of water leakage may be identified as follows. A neighborhood relationship is derived for establishing top, bottom, left and right neighbor pixels of each single pixel. A Neighbors Size (NS) is assumed for defining the domain of existence of leakage around thermal edges as shown in FIG. 6B. Data is then filtered off according to the adjusted value of AT obtaining results as shown in FIG. 7. In such illustration, it is clear that a thermal anomaly related to water leakage has been successfully detected.

Similarly in another embodiment, by setting a suitable predetermined AT, AB and OB, thermal anomaly at different predetermined temperature may be found. Heated spot on the roof is one of the signature characteristics of roof debonding in thermal image. By setting AT at higher temperature, for example 45 deg C. and setting the right-hand side of AT as AB and left-hand side of AT as OB in the histogram chart of a thermal data extracted from a thermal image of a roof, roof debonding may be detected as shown in FIG. 8. Of course, these are only examples and are not intended to limit the scope of the thermal anomalies detection and/or thermal sub-module of the present invention. The model is built using up-to-date computer vision technique. All anomalies are mapped at their locations in the image, and they are assigned a unique alphanumeric id. After the macro inspection as mentioned above, the severity of each single anomaly is then assessed through a thorough micro-inspection. During micro-inspection, several attributes are extracted from the detected anomaly and accordingly the status of the anomaly is duly assessed.

Greater detail of the surface anomalies detection is now discussed herein. The surface anomalies detection in the visual sub-module includes visual identification step and visual assessment step.

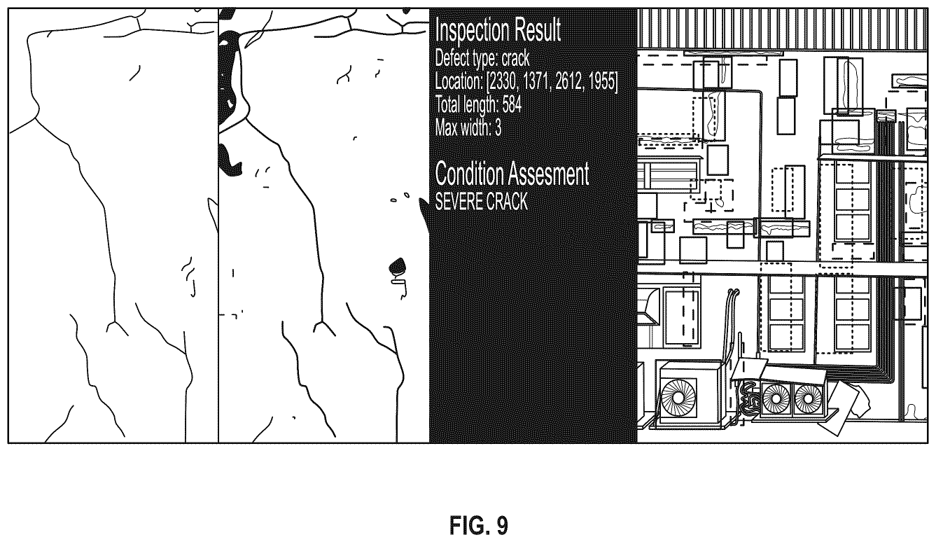

At visual identification step, all types of the defects are first identified on an image from the sensed data. The defects include cracks, stains, reinforcement corrosion, missing tiles, concrete honeycombing, concrete delamination, concrete peeling, concrete bulging, concrete spalling, exposed bars, lift cables fractures or fatigues and/or obstacles at escalator comb section. The defects were identified using artificial intelligence powered image classification by feeding the visual image to the defect identification trained model. Referring to FIG. 9, defects are identified and assigned to bounding boxes delimiting the region in which each single defect falls. All defects are mapped at their locations in the image, and they are assigned a unique alphanumeric id. The severity of each single defect is then assessed through a micro-inspection within the bounding boxes in the assessment step. In some embodiments, the visual identification step also known as macro inspection.

At assessment step, each of the identified defects is then assessed by a corresponding defect assessment trained model to determine its severity. Micro-inspection within each bounding box begins with feeding a cropped image of the defect in that bounding box to the corresponding defect assessment trained model. Referring to FIG. 9, corresponding assessment of severity on the crack is shown. In some examples, at least one defective zone in the cropped image may be labelled by domain expert before feeding to the corresponding defect assessment trained model. In some embodiment, the assessment step also known as micro inspection.

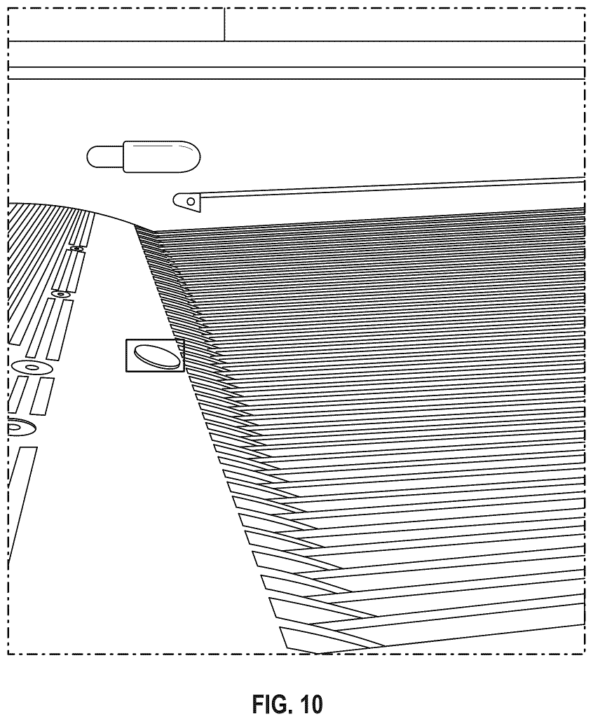

Similarly, referring to FIG. 10, the obstacles at escalator comb section was identified and its severity may be assessed using corresponding trained model. In some examples, the severity of the obstacles is classified based on the sizes and/or shapes of the obstacles.

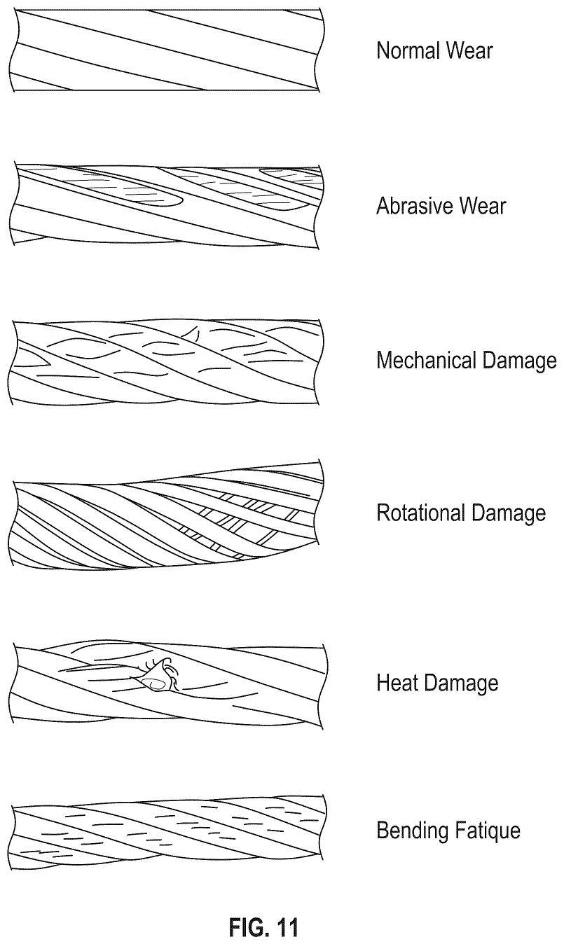

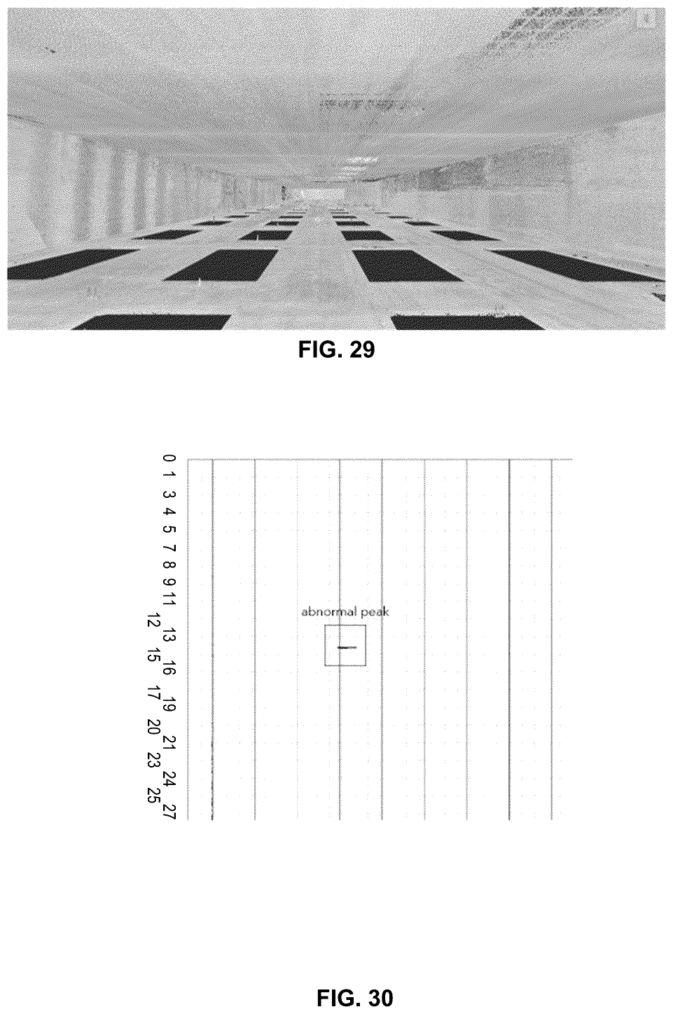

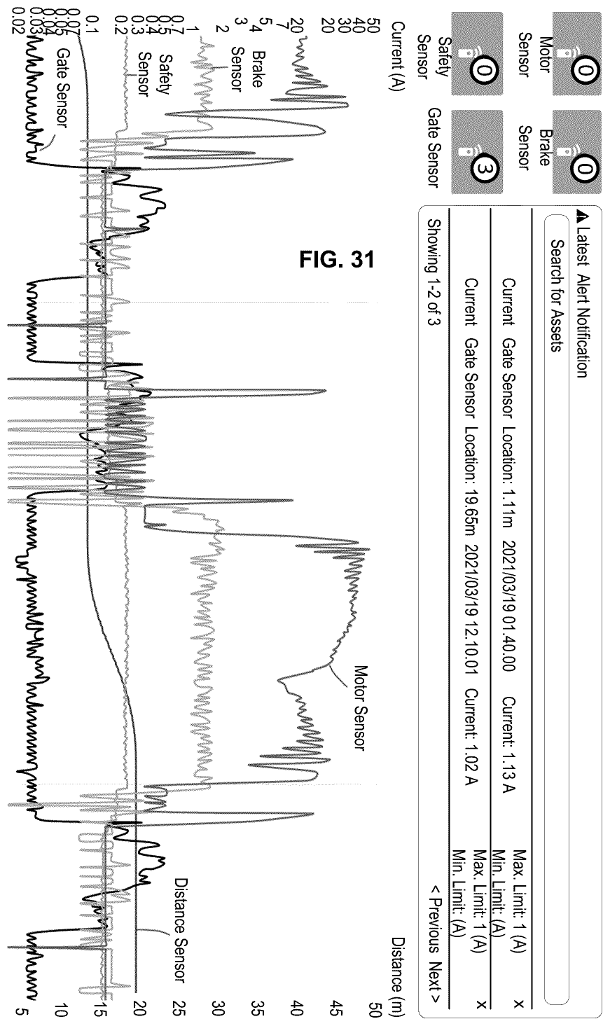

Now referring to FIG. 11, different types of cable defects may be identified at the identification step. The defects identified may include but not limited to abrasive wear, mechanical damage, rotational damage, heat damage and bending fatigue. The degrees of severity of each defect may then be assessed at the defect assessment step by corresponding defect assessment trained model. In some examples, the attributes used to detect cable defects at the identification step include but not limited to non-uniformity of cable wires, stains of the cable, color change of the cable and elongation of the cable. FIGS. 30-31 provide more comprehensive data set showing the various defects as identified when incorporating one or more features of aspects of the invention.

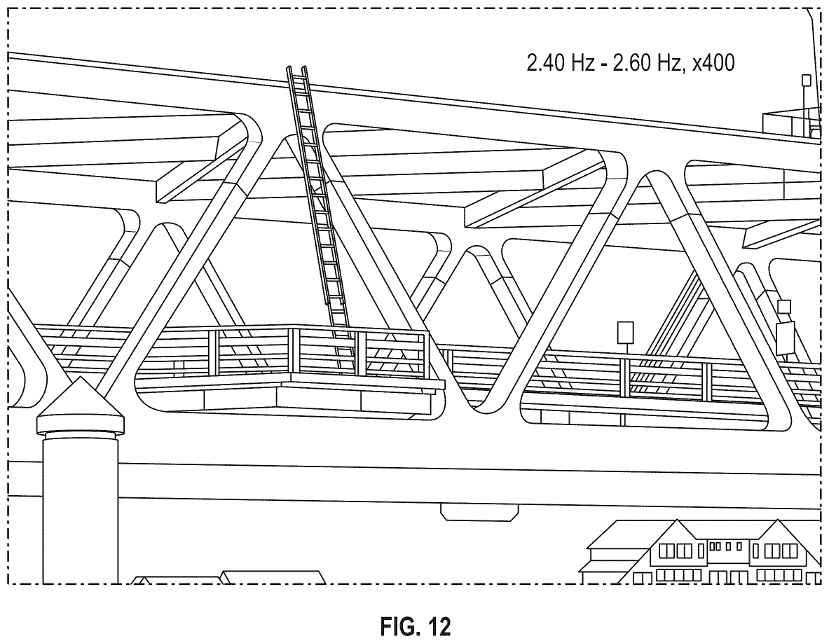

Now referring to FIG. 12, potential structural defect of a bridge may be detected through vibration analysis. The vibration analysis is carried out by taking the structural change from a stationary camera. Normally the bridge does not show significant deflection. However, through our surface anomalies detection in the visual sub-module, this structural change is amplified, and its vibration behavior may be studied and analyzed. The geometric change along time may be modeled by vibration analysis. Any anomalies detected may indicate structural defect of a bridge.

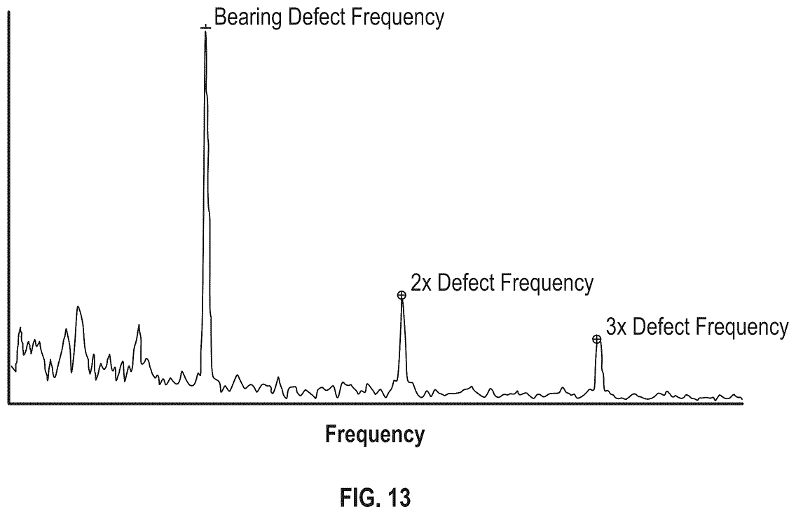

Greater detail of the vibration anomalies detection is now discussed herein. The anomalies include but not limited to machine imbalance, bearing imbalance, bearing misalignment, casing looseness and shaft bending. The vibration anomalies detection in the vibration sub-module includes vibration identification step and vibration assessment step. During vibration anomalies detection, vibration sensed data is fed to the defect identification trained vibration model. Referring to FIG. 13, there are plurality of spikes at certain frequencies which may be correlated with potential defects of a machine (vibration signatures). The defect identification trained vibration model compared collected vibration sensed data against the existing database containing various vibration signatures, and identify whether a machine has any potential defects.

At vibration assessment step, each of the identified defects is then assessed by a corresponding vibration assessment trained model to determine its severity. The vibration amplitude, velocity and acceleration data in the vibration sensed data are transformed into frequency-based analysis through Fast-Fourier Transform (FFT). Abnormal peaks and patterns may be reflected through this transformation. Potential defects may be identified by comparing against its normal condition. Defects are identified and their severity are highlighted in the frequency spectrum as well as time spectrum. Periodic inspection on defect location normally will show an increase in vibration amplitude or increase in severity. This is because, for example, the abnormal vibration starts from internal components to external casing of equipment as time goes on.

The defects data includes but not limited to type of defect and/or severity of the defect obtained in the anomalies detection is then fed to the prediction step as previously discussed.

In one embodiment, the anomalous behavior is bearing imbalance, where (i) a shaft's geometric centerline does not coincide with a mass centerline or (ii) the center of mass does not lie on the axis of rotation. There may be two types of imbalance static imbalance and couple imbalance. In this embodiment, the Vibration Analysis Model may analyze the vibration amplitude—frequency spectrum (in frequency domain) transformed from/based on the vibration sensed data. The defect identification trained vibration model may recognize any imbalance, which is often associated with misalignment, looseness or other fault condition, by capturing any abnormal high peak(s) in the spectrum at predetermined frequency (e.g., at predetermined rotational rate of the shaft). It further may identify the defect type by distinguishing its associated signature(s) found in the frequency spectrum. Similarly, the vibration assessment trained model may deduce the severity of each defect by recognizing the associated signature(s) found in the frequency spectrum.

In some examples, the vibration sensed data may contain vibration in horizontal direction as the amplitude may be higher compared to the vertical direction due to stiffness. In some other examples, the vibration sensed data may contain vibration in a vertical direction.

### Example

Data collection for inspection of facades is undertaken with Unmanned Aerial Vehicles (UAVs) either through an autonomous pre-programmed flight or through a human piloted flight. Data analysis is performed through implementation of up-to-date AI-powered algorithms for automated detection of the defects on visual and thermal images. All the recognized defects and thermal anomalies are labelled on the building facade so that a comprehensive evaluation of the asset current status may be visualized. In this example, implementation of AI-powered inspections may save up to 67% in time and 52% in costs against the most commonly adopted practices in industry with an average accuracy of 90.5% and 82% for detection of visual defects and thermal anomalies, respectively.

Data Collection: Tools such as visual and thermal cameras mounted on UAVs enable professionals to collect visual and thermal photographs (data) of building facades efficiently and accurately whilst reducing operational costs and safety risks. UAVs provide building inspectors with a unique aerial perspective. Drones allow easy access to remote or inaccessible areas (which may include natural or human-built obstructions) without compromising safety. Another benefit of utilizing UAV for building inspections is the non-destructive and non-contact approach. This increases the accuracy of collected data and allows for repetitive data collection in monitoring historical or structurally damaged buildings.

According to the above statements, inspections are performed employing a drone equipped with a visual and thermal camera to conduct rapid survey of building facades.

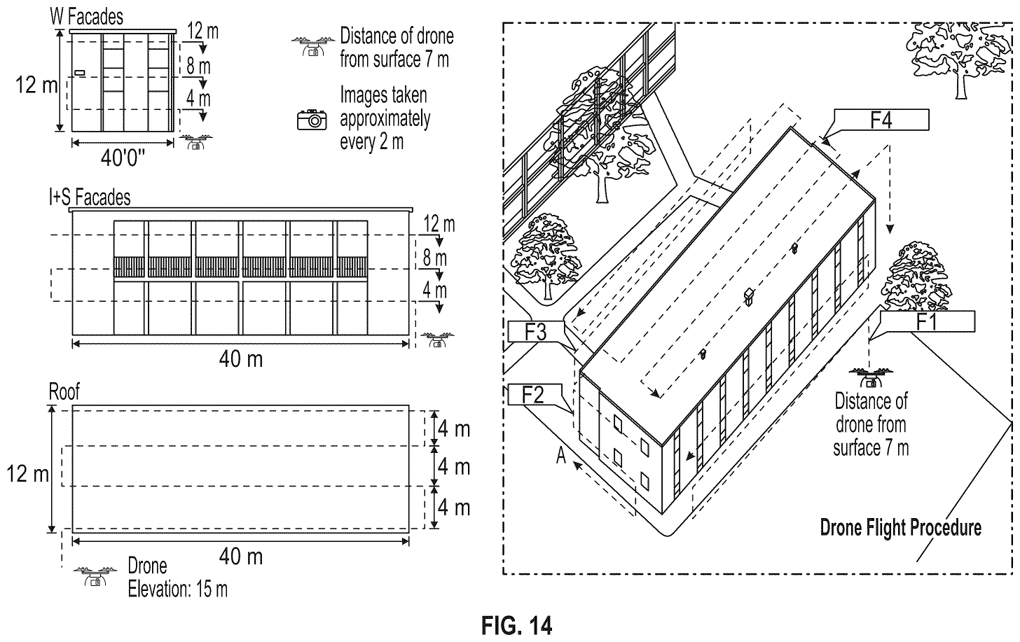

Flight-path Design: Whilst UAVs are starting to be employed in building inspection activities, a comprehensive common ground for UAV building inspection procedure has not been established yet. In this example the procedure highlighted is shown in FIG. 14 along with the recommendations for data collection given below. The flight path may either be remotely controlled by a pilot or pre-programmed using a third-party software.

Recommendations for Data Collection: The analytics, to be presented in the next sections, have been designed to analyze visual and thermal data in conformance with the following specifications: (1) outdoor environmental conditions have to be measured and it has to be determined if the climate is suitable for flight (temperature, humidity, wind speed, cloud coverage, etc.); (2) indoor temperature has to be measured (or assumed) and resulting temperature difference has to be calculated. It has to be determined whether the difference is within acceptable range (10° C. or more); (3) building usage (building type, operating hours, etc.) has to be determined; (4) occupants have to be notified about the flight and they have to be asked to minimize radio and Wi-Fi interference; (5) for flat facades that are mostly vertical, the flight path should begin on a predetermined corner and follow vertical bays upward, move across to the next bay, and proceed downward. This pattern is repeated until the entire facade has been documented and the drone moves on to the next facade in a similar manner. For flat facades that are mostly horizontal, the path should begin at a predetermined corner and continue to the right before moving up a bay and continuing in a linear manner to the left, repeating until the entire façade has been documented. After capturing facades, the drone should capture images of the roof in a similar grid manner, starting from one corner and moving in either a horizontal or vertical pattern along a superimposed grid until the entire roof has been captured (see FIG. 14); (6) minimum images resolution should be 640×480; (7) photos should have 70%-80% overlap; (8) the UAV should be at a distance of about 3-7m from the facade, depending on inspection site and building type; (9) during the inspection, the pilot should keep the camera in such a way that the projection of the camera on the facade is always orthogonal; (10) the subject being inspected should always be in clear focus at a fixed distance; (11) the data should not include any object lying at a distance in between the facade being inspected and the camera; (12) the data ideally should not include any regions not undergoing thermal inspection such as sky, clouds, neighbor buildings, people, trees etc.; (13) common false positives occur on the glass of the window where the reflection of the drone or whatever is in front is detected on the reflection itself. If and when possible, avoiding such areas will be helpful for improving accuracy of the analysis; (14) It is important to notice that visual and thermal data are sensitive to weather conditions. Climatic factors such as rain, heavy wind and snow may considerably affect the outcome of an inspection. Other environmental factors, such as solar radiation, cloud coverage, wind speed and humidity may affect the visibility and the external surface temperature. Additional recommendations are taken as reference for ensuring high quality of collected data, for example a protocol for usage of UAVs for thermal inspections as described in Entrop A G., Vasenev A. Infrared drones in the construction industry: Designing a protocol for building thermography procedures. Energy Procedia. 2017; 132:63-68.

Visual Analytics: By collecting increasing amount of data along with corresponding spatial information, data-driven based classification and recognition approaches like Convolutional Neural Network (CNN) show a great potential to provide more solid and scalable inspection results for structural assessment than conventional approaches. Accordingly, this example has proposed an analytics approach for Deep Learning (DL) powered defects classification based on visual data, namely labelled herein as ‘Visual Analytics’. The visual analytics workflow is hereby described as follows.

Visual Analytics Workflow: A method for detection and analysis of architectural defects on facades is proposed herein. The algorithm is structured in a two-stage scheme: (1) Macro inspection, in which the defects in the image are localized using a Deep Neural Network (DNN) and (2) Micro inspection, in which the localized defects from stage (1) are analyzed to assess their severity. In the following, the steps taken for the development of the method are hereby discussed.

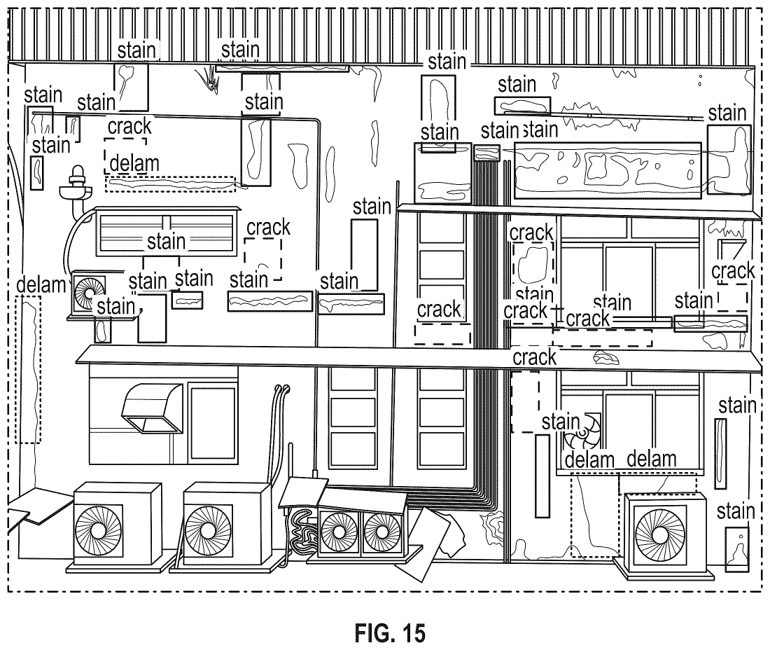

Data Preparation and Labelling: In this example, the inventors have identified the structural defects more likely to be visible on facades of reinforced concrete (RC) buildings, namely cracks, delamination and stain. A crucial factor for training a DNN is availability of enough annotated data, so that the model may successfully learn features from the inputs. Due to a shortage of existing publicly available dataset on local Hong Kong architecture, a training dataset was collected by the inventors for defect detection in macro inspection stage. The training dataset is collected according to the specification given in Data Collection, the Flight-path Design and Recommendations for Data Collection above. Data labelling is a very tedious and time-consuming process which requires employment of civil engineering specialists to manually analyze the above-mentioned dataset. The collected images are carefully annotated by a civil engineer expert, using a bounding box label around each defect available in the image. FIG. 15 illustrates an example of an annotated image from the training dataset. In total, the training dataset for macro inspection is comprehensive of 1000+ images. The VIA annotation tool is used to perform the image labelling process.

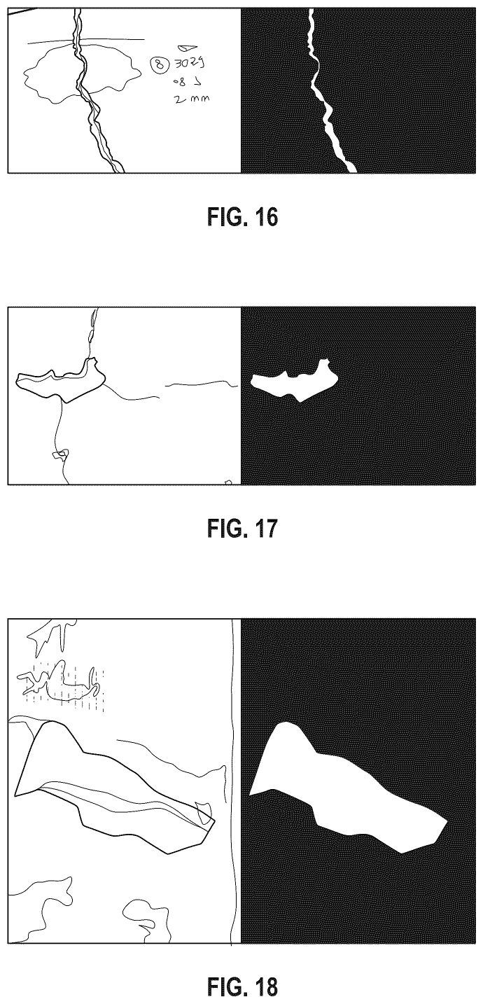

Training data preparation for the micro inspection stage requires greater accuracy, hence results to be much harder. Annotation had to be performed pixel-wise, namely all pixels had to be annotated as belonging or not belonging to a defect. A MATLAB GUI was developed for defect segmentation. The dataset for micro inspection model training is comprehensive of collected data used for macro inspection. The shape of the defect region tends to be stochastic in distribution, hence it is needed that areas are manually labelled (see FIGS. 16-18).

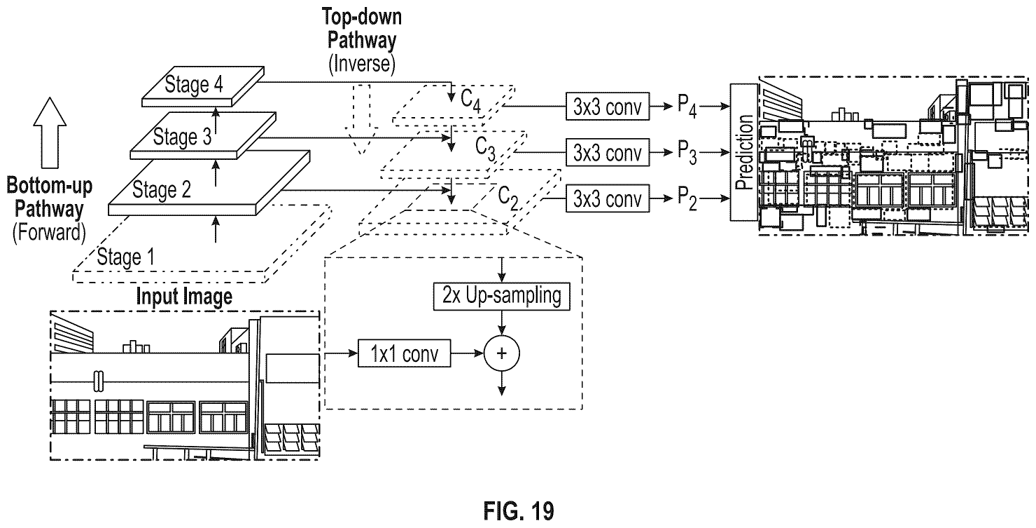

Micro Inspection: Macro inspection is performed through a fine-tuned CNN-based object detector which has shown its ability to deeply understand image high level features and provide effective discriminative features. The model takes an image as input and detects the desired objects via finding a bounding box around the object and assigns a class label to each. A representation of the network architecture is given in FIG. 19. The network receives an RBG image at the input and detects the location and labels the defects at the output. The network utilizes a ResNet50 architecture as the backbone, to extract high-definition image features for the supervised learning task. The input image is analyzed in different scales, in an operation called Feature Pyramid Network (FPN), to allow the detection of objects at different size. Feature maps at different scales are then blended to perform the object detection task.

A pretrained ResNet50 is utilized at the network's backbone to hasten the model convergence process during training. To train the network, for the first 15 epochs, the backbone weights are frozen and only the network head's parameters are optimized. After the 15th epoch, all the network parameters are optimized using Adam optimizer. The network is trained for 200 epochs with a batch size of 4, with early stopping enabled to terminate the training in case of no loss improvement. The initial learning rate in Adam is set to 1e-5 and an adaptive learning rate scheduler is set to further reduce the loss.

Micro Inspection and Defect Assessment: Micro Inspection is performed using a Fully Convolutional Network (FCN) based on object segmentation to assess the severity of detected defects from the macro inspection stage. An FCN receives the defect images, cropped around the macro inspection estimated bounding boxes and resized to a 224×224 resolution, and produces a binary output image. The output binary is represented as a matrix of pixels with values of 255 at the defect locations and 0 otherwise. This binary image is then utilized to analyze the defect attributes within each detected bounding box. The conventional FCN-8 object segmentor is used to generate the binarized targets from the input RBG images. FCN-8 utilizes a VGG16 network at the encoder to generate features discriminating the desired object from the background. The feature maps at different levels are then up-sampled and blended to generate the output segmented image at the decoder part. An FCN is trained for each of the defect classes crack, delamination and stain, separately. In one embodiment, the details of the FCN-8 network architecture may be applicable according to some embodiments. For example, the network receives an RBG image at the input and generates the segmented output. A pretrained VGG16 model is utilized in the encoder stage of the network. The network is trained to minimize the Mean Squared Error Loss (MSE) on the output binary images. The Adam optimizer is used to optimize the parameters of the network. The network is trained for 50 epochs with a batch size of 32, with early stopping enabled to terminate the training in case of no loss improvement. The initial learning rate in Adam is set to 1e-5 and an adaptive learning rate scheduler is set to further reduce the loss. All networks related to the Macro and Micro inspection are implemented in TensorFlow backend on a NVIDIA TITAN XP GPU.

Defects assessment in the form of cracks, delamination and stain quantification is performed by assigning several attributes to each defect class, using the results from the micro inspection. Such attributes, including crack width and defect area to bounding box ratio, are used assess the severity of each defect in conformance with, and to categorize their severity level as ‘Minor’, ‘Moderate’ or ‘Severe’.

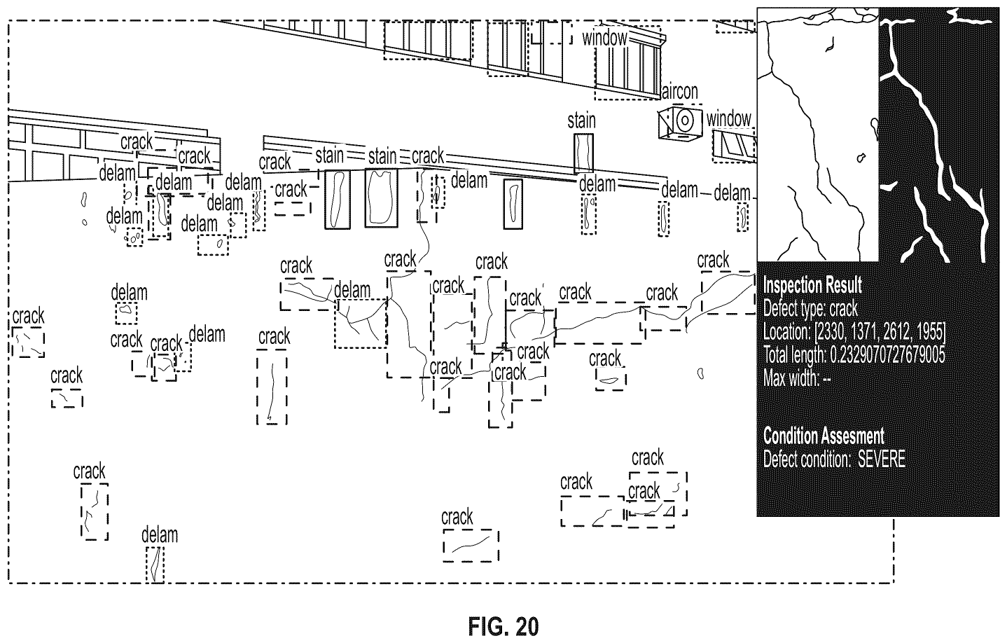

Post-processing and Defects Labelling: After the model is well trained, it may be used for defects classification. For a constant sub image size, a sliding window is used to perform detection throughout the whole image. Then each image is labelled with crack true, delamination true, stain true or no defects. After training on the initial dataset, the model is tested, the detection results are reviewed, and then final decisions are made. The labelled images are used for re-training purpose and the model is constantly improved inspection-after-inspection. FIG. 20 shows a sample application of visual analytics through macro inspection and micro inspection on the facade of a RC building. It is noted that besides training for defects classification, as mentioned in Data Preparation and Labelling above, training data includes also labels of other elements typically present in Hong Kong architectures of RC buildings, such as windows and air conditioners.

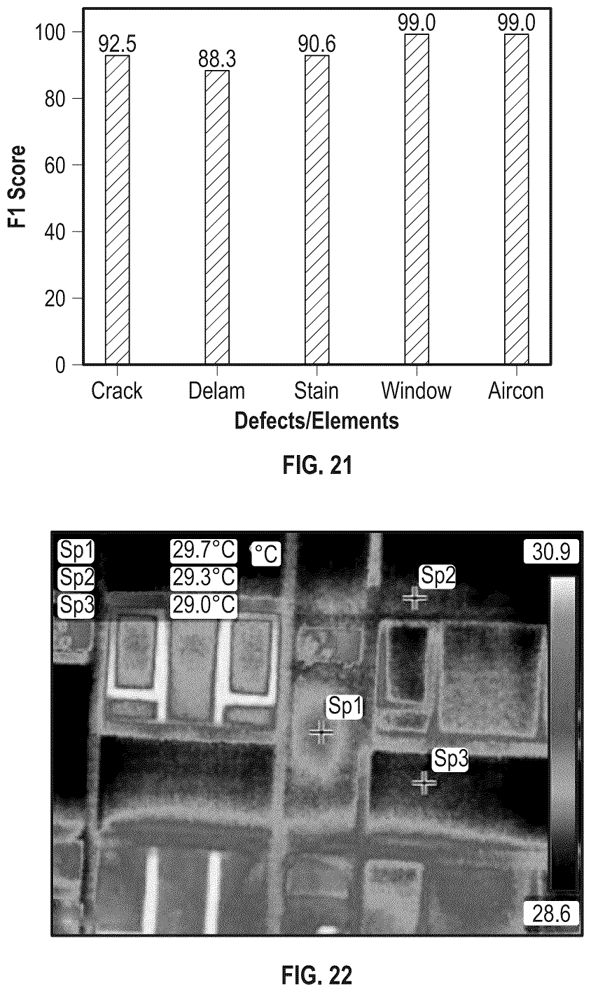

The above-mentioned process of labelling and re-training has been undertaken through several inspections and the training database has been extended to 18,000+ labelled images which have led to the improved accuracy reported in FIG. 21. From this figure, it may be noticed that accuracy in windows and air conditioners detection is much greater than for defects detection. Such result is attributed to the fact that windows and air conditioners have more articulated and distinctive features than defects, hence their detection represents a less complex problem. Regarding accuracy of defects, the accuracy difference is attributed to data availability in the dataset, which is partitioned with 40% cracks labels, 27% delamination labels and 33% stain labels. Additionally, delamination and stains may in some cases be mis-detected due to their similar distinctive features such as color and shape.

Infrared Analytics: Nowadays there is still lack of a reliable and automated procedure capable of replacing qualitative approaches for thermal inspections. By collecting increasing amount of data along with corresponding spatial information, data-driven based classification and recognition approaches based on computer vision (CV) show the potential to provide more solid and scalable inspection detection results for structural assessment than conventional approaches. Ideally it would be of primary interest to detect structural defects in thermal images. However, due to the noisiness of thermal images, AI-powered identification of structural defects from thermal images may not be the most suitable approach. The inventors propose an analytics approach for CV-based anomaly detection on thermal data, namely labelled herein as Infrared Analytics'. In such approach thermal anomalies are detected in an automated fashion and diagnosis of thermal anomalies is undertaken in post-processing phase for assessing the causes. A comprehensive description of the infrared analytics workflow is described as follows.

Infrared Analytics Workflow: A method to detect and analyze anomalies in a thermal image is proposed herein. Similarly, to the previously covered visual analytics (sec Visual Analytics Workflow above), the infrared analytics algorithm is structured in a two-stage scheme: (1) macro inspection, in which the thermal anomalies are detected using a CV-based algorithm and (2) micro inspection, in which the localized anomalies from stage (1) are analyzed to assess the anomaly severity. In the following, the steps taken for the development of the method are hereby discussed.

Data Preparation: After research studies and analysis of inspection demand from the industry, the authors have identified the structural defects more likely to cause anomalous thermal behavior in concrete, namely leakage, debonding and moisture. It should be noted that, similarly as for data preparation for visual analytics (see Data Preparation and Labelling above), web keyword search for such structural defects provides inconsistent results. Moreover, finding relevant online sources for thermal photographs is challenging. Accordingly, all the used data was collected by the authors throughout several thermal inspections.

A database of 1000+ images, including leakage, debonding and moisture defects, make up the initial database. Data labelling of thermal images is a very tedious and time-consuming process which requires employment of infrared civil engineering specialists to manually analyze the above-mentioned dataset (FIG. 22).

Macro Inspection: The macro inspection algorithm is built according to the concept that a thermal anomaly is defined as a region where sudden or abnormal temperature changes happen in the thermal image. Therefore, the main aim of the detection algorithm is to find sharp temperature changes on the thermal image. In this framework, a thermal image is considered as a two-dimensional matrix, whose cells (pixels) are temperature values. A naïve solution to segment out the anomalous regions would be looking for cold enough pixels (in summer, for outdoor images) and labelling them as anomalous. However, this approach may lead to multiple false positive results since such pixel-wise separation works as a simple filter detecting cold regions without taking any distinctive characteristic of thermal anomalies into account. Sharp temperature changes are delimited by thermal edges, hence representing the contour of anomalous regions. Thereafter, it may be inferred that thermal anomalies are regions bounded by thermal edges. Yet, the data may contain other non-relevant visible edges that will be detected on the same image which do not bound any thermal anomalies (e.g. trees, clouds etc.). In order to address this challenge, the proposed method eliminates such false detections and eventually segments out the anomalous regions by not only detecting thermal edges, but also following along each side of the edge to filter out false positives, and then applying thermal anomaly segmentation on the anomalous regions. The algorithm for macro inspection is composed of: Dynamic Calibration and Identification of Thermal Edges and Anomaly Segmentation, and it is introduced as follows.

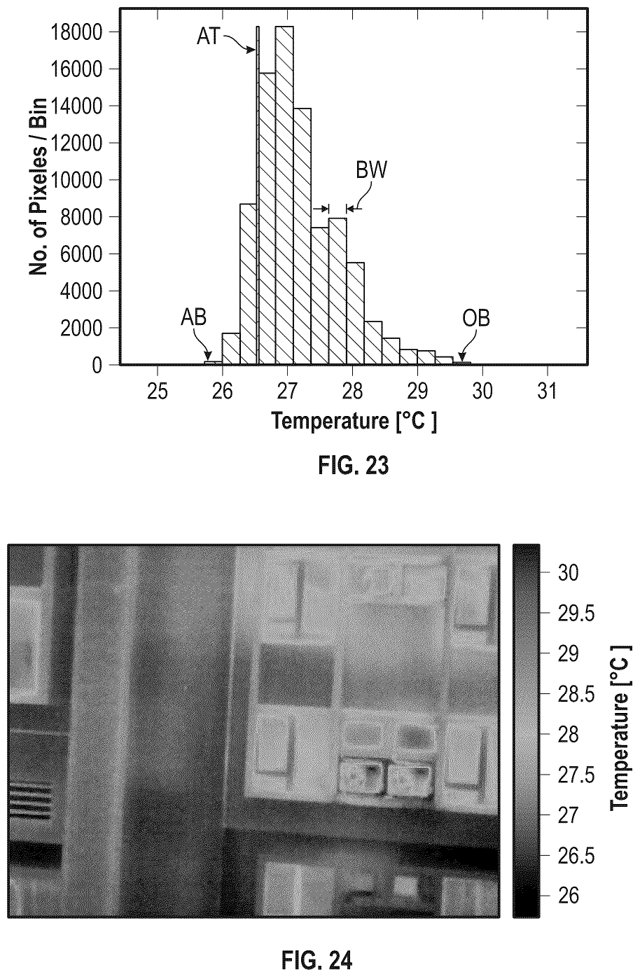

Dynamic calibration: The first stage of the algorithm outputs two thresholds that are calculated per image based on the temperature distribution and seasonal conditions. Instead of defining a strict, pre-set threshold, the algorithm finds appropriate thresholds for each image before further processing. These two thresholds are referred to as Anomaly Threshold (AT) and Bin Width (BW). The AT is used to determine which pixels are anomaly candidates, while the BW is used to assess if there is temperature change happening at a certain region. They are computed by employing a temperature histogram, whose size is dynamic based on the representativeness of the histogram bins (see FIG. 23) of an image to be inspected (see FIG. 24). The Anomaly Bins (AB) are defined as the bins where anomalous pixels values fall and they lay behind the AT, and the Opposite Bin (OB) is defined as the bin at the opposite side of the AB associated with greatest temperature values. In order to eliminate some of the false positives, a lower a limit is used on the representativeness of the OB, since the expectation is for it to contain enough number of values. If the OB contains less than a, the values that fall into it are removed and the histogram is recalculated until the opposite bin has strong representativeness. It is assumed that if there is more than one peak in the histogram, then the pixels distribution may contain irrelevant information which may lead to false positives (such as background sky). In such case, it is likely that relevant information is at mid-range temperatures. Eventually irrelevant peaks and their bounding pixels are discarded. Next, an upper ß limit is used on the AB, which is not expected to dominate the temperature distribution since the total area of potential anomalous regions is likely to occupy a smaller portion of the entire image. If the representativeness of the AB is greater than B, the histogram's number of bins is incremented and recomputed until the limiting condition is met. The abovementioned a and B limits are variable percentage values that are tuned according to thermal data distribution depending on the building type.

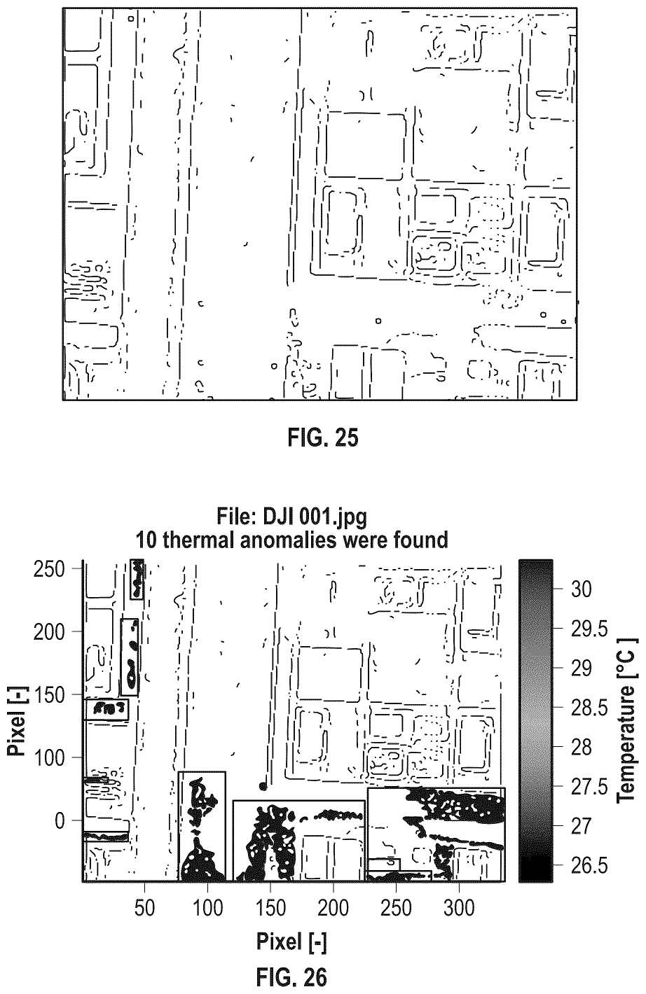

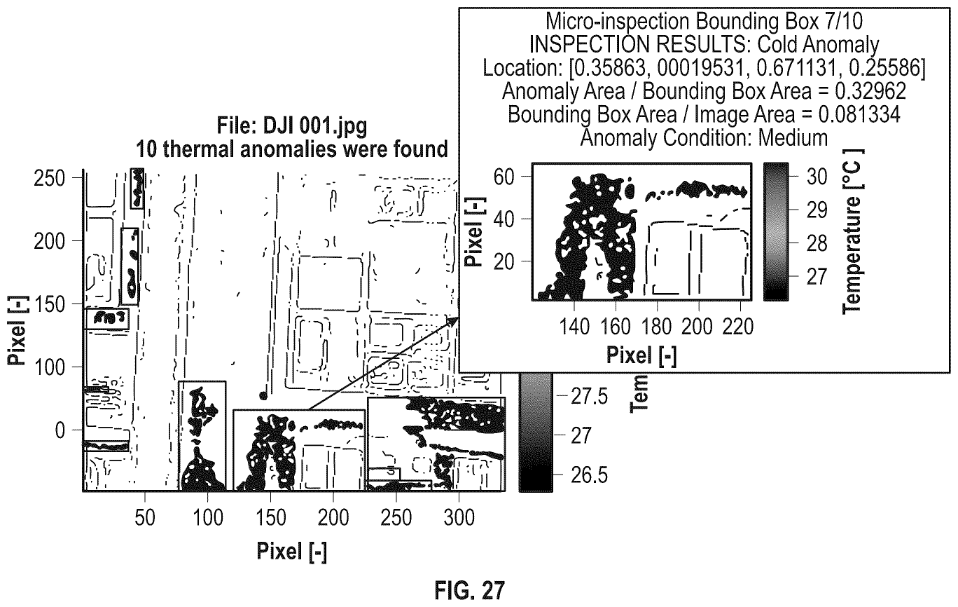

Identification of Thermal Edges and Anomaly Segmentation: In the second stage of the algorithm, the thermal edges are found by using a Canny edge detector. By utilizing the thresholds established in the earlier stage, the irrelevant edges generated by the Canny edge detector are filtered out. The filtering operation is done by processing every pixel on each edge line along the edge direction and judging if they are pixels on the edge of a thermal anomaly or not. During this process, the algorithm compares the values in the neighborhood of the pixel that is currently being processed. A neighborhood relationship is established with the neighborhood defined as set of values perpendicular to the edge direction. If the greatest value in the neighborhood is greater than the AT (that is, the corresponding pixel does not fall in the AB), the corresponding edge pixel is removed. If it is lesser than the AT, then the algorithm checks whether the difference between the highest and lowest values is larger than the BW. If the difference is not larger, the current edge pixel is removed. Otherwise, the algorithm keeps the edge pixel and moves on to the next one. Anomalous edges are found after processing all pixel on each edge and performing elimination (See FIG. 25). As a result, the actual anomalous regions enclosed by these edges are highlighted by a bounding box (see FIG. 26).

Micro Inspection and Anomaly Assessment: Micro inspection is performed through an in deep inspection of all the found thermal anomalies. Similarly, to defect assessment introduced for visual analytics (see Micro Inspection and Defect Assessment under visual analytics above) micro inspection is applied to assess the severity of detected anomalies from the macro inspection stage. The severity of thermal anomalies is assessed conforming the assessment criteria used for delamination and stain.

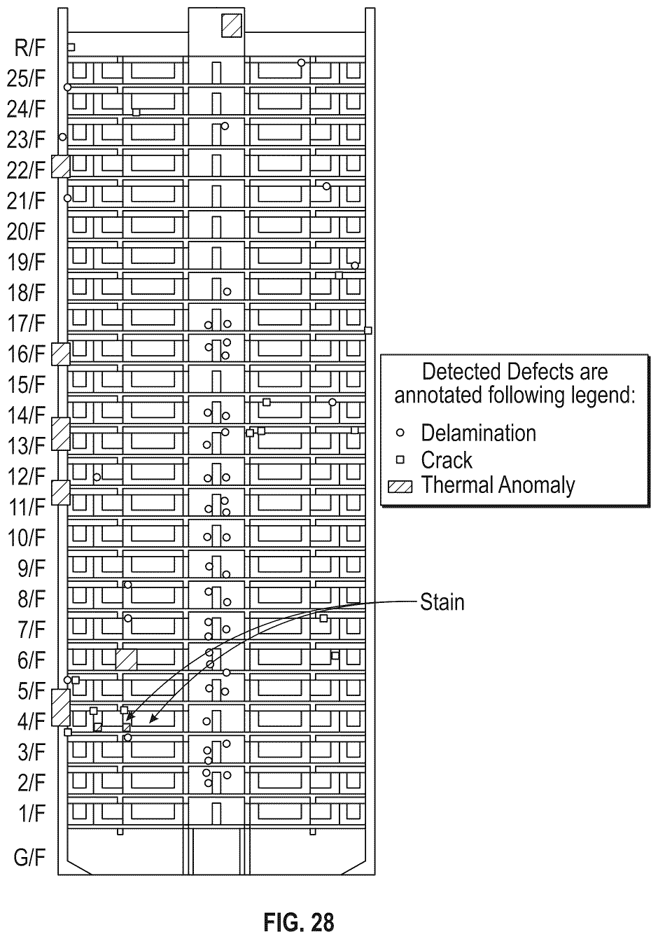

Post-processing and Anomalies Labelling: After the CV model is well built, it may be used for anomalies detection. Each image is labelled as thermal anomalies true or no thermal anomalies. Since the model is CV-based, all the detection results are reviewed, and then final decisions are made. For industrial applications, the algorithm tends to always be conservative in terms of anomalies detection, hence it is more likely to detect false positives than having any false negative. The outputs of the infrared analytics are reviewed by an infrared specialist to assess eventual misdetections and diagnose structural defects causing the thermal anomaly. The false positives are used for development purpose and the model is constantly improved inspection-after-inspection. FIG. 28 shows a sample application of infrared analytics through macro inspection and micro inspection on the facade of a RC building.

The abovementioned process of development based on database amplification has been undertaken through several inspections and the database has been extended to 4,000+ thermal images, which have led to an overall accuracy of 82%. This accuracy is indicative of the model recall, representative of the percentage of total relevant results correctly classified by the algorithm. Misdetections have been mostly attributed to the inevitable presence of irrelevant objects, reflections on windows glass and poorly collected data (not conforming specifications given in Recommendations for Data Collection.

Case Study for Industrial Application: In this section, the industrial application of the AI-powered inspections of the present invention is hereby reviewed against the solutions currently available in the market. The inspected site may be a facade of one out of 22 individual blocks providing a total of 1,502 domestic units with areas ranging from 434 to 2,000 square feet. The inspected 25 stories facade is a surface area of 27×65 m², and it is displayed in FIG. 28. The survey flight took place in one single day using four batteries taking visual and thermal photographs. The flight time was 300 minutes and 1000+ photographs were captured. The facade was inspected using a Matrice 210RTK with an X5S visual camera paired to an XT2 thermal camera. The inspection was conducted using a pre-programmed flight path designed using the Litchi App v2.5.0. The operation crew was composed of one pilot-in-command, and one observer/spotter. The image processing through the described analytics and endorsement of results by a certified professional took 4 days. The detected defects are labelled under four major categories of inspection outcomes including: cracks, delamination, stains (detected in visual data) and thermal anomalies (detected in thermal data). Such defects are displayed in FIG. 28. Through such representation, all the recognized defects and anomalies are mapped at their location in such a way that a comprehensive understanding and evaluation of the current status of the facade may be performed.

With reference to such case study, Table 1 shows a comprehensive comparison between qualitative solutions readily available in the market and the proposed framework for AI-powered inspections.

TABLE 1

| | | | AI-powered |
|---|---|---|---|
| | Facade inspections | Facade inspections with | inspection (present |
| | with scaffoldings | gondola | invention) |
| Risk | High | Medium/Low | None |
| Manpower | 0.011 | 0.0057 | 0.0023 |
| [people/m2] | | | |
| Tools & | Planks, cross bars, | Construction cradle | UAV paired with |
| Equipment | frame, connecting | (gondola), suspension | visual and thermal |
| | pins and clams, | mechanism, electric | camera |
| | base plates, safety | hoists, safety lock, | |
| | barriers, level, tape | electric control box, steel | |
| | measure, spanners, | wire rope, safety rope, | |
| | claw hammer, | counterweights, personal | |
| | personal | protective equipment | |
| | protective | | |
| | equipment | | |
| Automated | No | No | depends on whether |
| Inspection | | | the inspection site is |
| | | | suitable for pre- |
| | | | programmed flight |
| Automated | No | No | Yes |
| Defects Detection | | | |
| End-to-end | 45+ | 15+ | 5 |
| Inspection Time/ | | | |
| m² [h] | | | |
| Inspection Price/ | 15.2+ | 9.5+ | 5.0 |
| m² [$HKD] | | | |

Conclusions: The present invention presents a novel approach for thorough AI-powered inspections of buildings. The facade survey is conducted using UAV paired with visual and thermal camera. The data is collected following specific recommendations. The collected visual and infrared data is processed using the proposed visual and infrared analytics methods. The developed algorithms enable automated and reliable defects detection on visual and infrared data of RC facades. The visual analytics algorithm is DL-based, and it has been trained on 18,000+ labelled photographs, whilst the infrared analytics algorithm is CV-based and it has been developed based on 4,000+ labelled photographs. Both techniques comprise of: (1) macro inspection for defects/thermal anomalies detection on collected data and (2) micro inspection for assessment of severity of defects/thermal anomalies. The conclusions of this examples are:
(1) facade surveys are operated with UAVs. Drone surveys provide with a unique aerial perspective and allow easy access to remote or inaccessible areas without compromising safety. Also, the usage of UAVs implies a much desirable nondestructive and non-contact survey. Building inspections performed with UAVs have reported greater accuracy of collected data compared to other inspection methods, whilst drastically reducing operation time;
(2) the inspection of the present invention provides a more scalable and effective way of inspecting buildings through automated collection, processing and analysis of extracted numerical data compared to conventional inspections which are undertaken in an interpretative manner, which may be subjective;
(3) AI-powered technologies are used for automating and drastically speeding up the inspection process, through deep learning (DL) algorithms for defect detection (including cracks, delamination and stain) on visual data and Computer Vision (CV) algorithms for anomaly detection on thermal data (due to leakage, debonding and moisture). Regarding detection of defects, accuracies of 92.5%, 88.3% and 90.6% have been achieved for cracks, delamination and stains, respectively. Regarding thermal anomalies detection, an accuracy of 82% is estimated. The method of the present invention includes a feature for assessing the severity of all found defects and thermal anomalies;
(4) the industrial applicability of the methodology is showcased, and a comparison has been made between readily available solutions in the market and the novel proposed solution. In general, it was observed that implementation of AI-powered inspections may save up to 67% in time and 52% in costs against the best available practice in the market;
(5) the outcomes of this research work are very promising, and the achieved accuracy and scalability of AI-powered inspection is facilitating a fast adoption in the industry. Through an ever-enlarging database and technological advancement, the authors believe that AI-powered inspections of facades have the potential to overtake the existing leading methodologies.

Of course, these are only examples and they are not intended to limit the scope of this patent application.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Python using, for example, conventional or object-oriented techniques.

The software code may be stored as a series of instructions or commands on a non-transitory computer readable medium, such as a random-access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above may be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of embodiments may become apparent to those skilled in the art upon review of the disclosure. The scope embodiments should, therefore, be determined not with reference to the above description, but instead should be determined with reference to the pending claims along with their full scope or equivalents.

One or more features from any embodiment may be combined with one or more features of any other embodiment without departing from the scope embodiments. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it may be understood by those of ordinary skill in the art having the present specification, figures and claims before them, that the corresponding structure includes a computer, processor, or microprocessor (as the case may be) programmed to perform the particularly recited function using functionality found in a computer after special programming and/or by implementing one or more algorithms to achieve the recited functionality as recited in the claims or steps described above. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one embodiment to the embodiments illustrated.

Further advantages and modifications of the above-described system and method may readily occur to those skilled in the art.

The disclosure, in its broader aspects, is therefore not limited to the specific details, representative system and methods, and illustrative examples shown and described above. Various modifications and variations may be made to the above specification without departing from the scope or spirit of the present disclosure, and it is intended that the present disclosure covers all such modifications and variations provided they come within the scope of the following claims and their equivalents.

What is claimed is:

1. A tangible non-transitory computer readable storage medium having stored thereon computer-executable instructions for analysing at least one defect, wherein the computer-executable instructions comprising:
receiving sensed data of visual image and video and combination thereof;
identifying at least one defect related information from the sensed data, wherein the at least one defect related information including a type of defect and a degree of severity of the defect; and
predicting a remaining lifetime of a target component where the defect was identified.

2. The tangible non-transitory computer readable storage medium of claim 1, wherein the predicting comprises obtaining analysed data from a remote source.

3. The tangible non-transitory computer readable storage medium of claim 1 wherein the identifying the at least one defect related information comprises feeding the sensed data into an artificial intelligence (AI) defect detection algorithm.

4. The tangible non-transitory computer readable storage medium of claim 3, wherein the AI defect detection algorithm is configured to process one or more of the following: a visual image, a thermal image, LASER point cloud, ultra-sonic data, vibration data, and electro-magnetic sensed data.

5. The tangible non-transitory computer readable storage medium of claim 4 further comprising increasing an accuracy of the identifying the at least one defect related information by feeding the AI defect detection algorithm with data including at least one predetermined feature of the sensed data or at least one predetermined feature of a training data.

6. A system for artificial intelligence enabled assessment and predictive analysis comprising:
an autonomous vehicle or robot coupled with a plurality of sensors, wherein the sensors include one or more of the following: a thermal camera, a visual camera, and a LASER scanner;
a computing device comprising a tangible non-transitory computer readable storage medium of claim 1 or 2,
wherein the visual camera is configured to collect at least one visual image of the target component or the target system;
wherein the thermal camera is configured to collect at least one thermal image of the target component or the target system;
wherein the LASER scanner is configured to collect at least one scan of the target component or the system;
wherein the computing device is configured to process data as a function of the collected visual image, the thermal image, and the LASER scan;
wherein the computing device is configured to identify at least one defect related information from the processed data, wherein the at least one defect related information including a type of defect and a degree of severity of the defect; and
wherein the computing device is configured to predict a remaining lifetime of a target component where the defect was identified.

7. The system of claim 6, wherein the plurality of sensors comprises a plurality of communication units for communicating with sensors disposed on a target component or a target system, wherein the sensors are configured to monitor conditions of the target component or the target system.

8. The system of claim 6, wherein the tangible non-transitory computer readable storage medium of claim 4 comprises a memory card associated with the computing device or a remote storage unit.

9. The system of claim 7, wherein the computing device further comprises a communication unit for receiving data from the remote storage unit via 5G mobile data transfer.

10. The system of claim 6, wherein the computing device further generates a defect report, and generating a recommendation on the report, wherein the recommendation provides information for predictive maintenance and an estimated remaining life of the target component or target system.

11. The system of claim 10, wherein the information for the estimated remaining life of the target component or target system comprises at least one of the following: building façade; Interiors of buildings; Buildings under construction; machines; and machine parts.

12. The system of claim 11, wherein the machines comprise one or more of the following: lifts, escalators, HVAC systems, pipelines, pumps, motors, power supply systems, switch boxes, gears, and bearings.

13. The system of claim 6, wherein the computing device is further configured to analyse an imminent defect condition as a function of the identifying.

14. The system of claim 13, wherein the computing device is further configured to transmit a SMS message or an electronic mail message to an owner of the target component or target system in response the analysed imminent defect condition satisfying a threshold.

15. The system of claim 10, wherein the computing device is further configure to calculate Safety Integrity Level (SIL) or Condition Score (CS) to indicate an overall health of the target component or system.

16. The system of claim 15, wherein the computing device is further configured to compare the SIL or CS to other target components or systems or compare the SIL or CS to similar target components or systems at different times.

17. A computerized-implemented method for analysing at least one defect of a structure comprising:
receiving sensed data of visual image and video and combination thereof;
identifying at least one defect related information from the sensed data, wherein the at least one defect related information including a type of defect and a degree of severity of the defect; and
predicting a remaining lifetime of a target component where the defect was identified.

18. The computer-implemented method of claim 17, wherein the predicting comprises obtaining analysed data from a remote source.

19. The computer-implemented method of claim 17, wherein the identifying the at least one defect related information comprises feeding the sensed data into an artificial intelligence (AI) defect detection algorithm.

20. The computer-implemented method of claim 19, wherein the AI defect detection algorithm is configured to process one or more of the following: a visual image, a thermal image, LASER point cloud, ultra-sonic data, vibration data, and electro-magnetic sensed data.
